(19) United States
(12) Patent Application Publication
(10) Pub. No.: US 2011/0007281 A1
(43) Pub. Date: Jan. 13, 2011

(54) PROJECTOR

(76) Inventors: Minoru Yoshikawa, Tokyo (JP); Masaki Chiba, Tokyo (JP); Katsuyuki Takeuchi, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 12/919,380

(22) PCT Filed: Mar. 25, 2009
(86) PCT No.: PCT/JP2009/055941

§ 371 Date: Aug. 25, 2010

(30) Foreign Application Priority Data
Mar. 26, 2008 (JP) 2008 079553

(51) Int. Cl. G03B 21/16

(52) U.S. Cl. 353/52

(57) ABSTRACT

A projector including a light source, an optical deflection element including a reflective surface, a mounting plate that holds the optical deflection element with a heat conductive member interposed between the optical deflection element and the mounting plate so that the reflective surface faces the light source, and a foreign matter intrusion preventing frame that is provided between the light source and the mounting plate so as to surround the reflective surface, the projector including: a heat receiving portion that is provided so as to surround at least one side of the optical deflection element; a heat radiating portion that is provided on the mounting plate outside the foreign matter intrusion preventing frame; and a heat pipe that includes the heat receiving portion and the heat radiating portion.

### TECHNICAL FIELD

The present invention relates to a projector, and more particularly, to a cooling structure of a projector that lowers the operating temperature of an optical deflection element when the brightness of the projector is increased, and makes the temperature of the optical deflection element less than or equal to a prescribed temperature.

Priority is claimed on Japanese Patent Application No. 2008-079553, filed on Mar. 26, 2008, the content of which is incorporated herein by reference.

### BACKGROUND ART

An example of a cooling structure of a projector, which uses an optical deflection element in the related art, is disclosed in Patent Document 1. A projector in the related art reflects light, which is emitted from a light source, by an optical deflection element and projects an image onto a screen (see FIG. 1 of Patent Document 1).

FIG. 3 is a cross-sectional view of a peripheral structure of an optical deflection element 101 in a projector in the related art. In the projector in the related art, the optical deflection element 101 is mounted on the mounting plate 104 with a heat conductive member 103 interposed therebetween. Further, a foreign matter intrusion preventing frame 105 is provided between a light source and the mounting plate 104 so as to surround a reflective surface 102. Furthermore, a light shielding plate 106 is provided between the light source 108 and the optical deflection element 101.

The cooling structure of the projector in the related art, which has the above-mentioned structure, operates as follows:

Light corresponding to a necessary color is selected from incident light 110, which is input from the light source 108, by the reflective surface 102 of the optical deflection element 101. Then, the incident light 110 becomes emitted light 109 and an image is projected onto a screen.

After that, heat, which is generated by electronic components such as a transistor for driving the reflective surface 102 of the optical deflection element 101, is discharged to the outside from a cooling surface 111, which forms the back surface of the optical deflection element 101 opposite to the reflective surface 102, by cooling air 112 that is blown by a cooling device (not shown).

As the cooling device, a liquid cooling device is used as described in Patent Document 1 or an air cooling device is used as described as the related art in Patent Document 1.

However, if the brightness of the projector is increased, the following problems occur in the cooling structure in the related art.

A first problem is as follows: since heat, which is transferred from the light source by radiation, is increased, there is a limitation on the cooling effect that uses only the heat radiation from the cooling surface 111 of the optical deflection element 101. Here, FIG. 4 shows a schematic view of heat transfer paths around the optical deflection element 101.

As shown in FIG. 4, a heat transfer path 115 for cooling of the optical deflection element 101 is a heat transfer path that is caused by the heat generation of an electronic component such as a transistor in the optical deflection element 101.

The temperature of the electronic components may be lowered by improving cooling performance on the cooling surface 111 of the optical deflection element 101. However, if brightness is increased, that is, if the amount of the incident light 110 is increased, the amount of heat transferred along a heat transfer path 113 is increased due to the radiation caused by the energy of the light.

In FIG. 4, the light shielding plate 106 is mounted between the light source and the optical deflection element 101 in order to efficiently apply light to the reflective surface 102 of the optical deflection element 101. However, heat radiated from the light source heats the light shielding plate 106, and is radiated to the optical deflection element 101. The amount of heat transferred along a path 114, which transfers heat through the light shielding plate 106, becomes a non-negligible amount.

The amount of heat transferred by radiation is radiated from the cooling surface 111 through an outer frame 116 of the optical deflection element 101. However, since thermal resistance in the optical deflection element 101 is high, there has been a limitation on the lowering of the temperature of the optical deflection element 101 even when the performance of the cooling device is improved.

A second problem is that cooling air cannot be blown to the reflective surface 102 of the optical deflection element 101. The reason for this is that the four sides of the optical deflection element 101 should be sealed by the foreign matter intrusion preventing frame 105 (FIG. 3) since an accurate image cannot be projected if foreign matter such as dirt intrudes into a gap between the reflective surface 102 and the light source 108.

FIG. 5 is a schematic view showing that the optical deflection element 101 is mounted on the mounting plate 104 and the periphery of the optical deflection element is sealed by the foreign matter intrusion preventing frame 105. The mounting plate 104 is made of metal such as copper.

Since cooling air 117 is blocked by the foreign matter intrusion preventing frame 105 even though being blown, heat transfer does not occur near the optical deflection element 101. For this reason, the mounting plate 104 radiates heat after heat is transferred in the cross-section of a thick portion of the mounting plate 104. Since there is a loss of thermal resistance caused by heat transfer, cooling performance is insufficient.

Patent Document 1: Japanese Unexamined Patent Publication, First Publication No. 2005-331928

### DISCLOSURE OF INVENTION

### Problem to be Solved by the Invention

The present invention has been made to solve the above-mentioned problems and an object of the present invention is to provide a projector that can control the temperature of an optical deflection element so as to make the temperature of the optical deflection element less than or equal to a prescribed temperature even when the brightness of a projector is increased.

### Means for Solving the Problem

(1) The present invention has been made to solve the above-described problems. According to an aspect of the present invention, there is provided a projector comprising a light source, an optical deflection element comprising a reflective surface, a mounting plate that holds the optical deflection element with a heat conductive member interposed between the optical deflection element and the mounting plate so that the reflective surface faces the light source, and a foreign matter intrusion preventing frame that is provided between the light source and the mounting plate so as to surround the reflective surface, the projector comprising: a heat receiving portion that is provided so as to surround at least one side of the optical deflection element; a heat radiating portion that is provided on the mounting plate outside the foreign matter intrusion preventing frame; and a heat pipe that comprises the heat receiving portion and the heat radiating portion.

The projector according to an aspect of the present invention further includes a path that transports heat by making radiant heat, which is increased due to the increase of brightness, be received by the heat pipe disposed close to the reflective surface of the optical deflection element before heat is transferred to the back surface of the optical deflection element. Accordingly, the cooling performance of the optical deflection element is improved.

Further, the optical deflection element is adapted so as to radiate heat after transporting heat, which is transferred by radiation, to the outside of the foreign matter intrusion preventing frame. Accordingly, it may be possible to suppress the temperature of the optical deflection element so that the temperature of the optical deflection element is less than or equal to a prescribed temperature. As a result, it may be possible to lengthen the product life of the optical deflection element.

(2) In the projector according to the aspect of the present invention, the heat pipe is formed integrally with the mounting plate.

(3) In the projector according to the aspect of the present invention, the heat radiating portion comprises heat radiating fins, and the heat radiating fins are mounted on the mounting plate.

Since the projector according to the aspect of the present invention has the above-mentioned fin structure, it may be possible to easily control the strength of the cooling air, the amount of radiant heat, the temperature that should be satisfied by the optical deflection element, and the like at the heat radiating portion.

(4) In the projector according to the aspect of the present invention, the heat receiving portion is thermally connected to the mounting plate and a light shielding plate provided between the light source and the mounting plate.

Since the projector according to the aspect of the present invention has the above-mentioned structure, the optical deflection element receives heat, which is transferred by radiation, before the heat is transferred to the cooling surface formed on the back surface of the optical deflection element. Further, the projector can radiate heat after transporting to the outside of the foreign matter intrusion preventing frame. For this reason, it may be possible to efficiently lower the temperature of the optical deflection element.

### Effect of the Invention

According to the projector of the present invention, even when the brightness of the projector is increased, it may be possible to suppress the temperature of the optical deflection element so that the temperature of the optical deflection element is less than or equal to a prescribed temperature.

### BRIEF DESCRIPTION OF THE DRAWINGS

FIG. 1 is a cross-sectional view schematically showing a cooling structure of a projector according to an embodiment of the present invention.

FIG. 2 is a plan view showing the cooling structure of the projector according to the embodiment of the present invention.

FIG. 3 is a cross-sectional view schematically showing a cooling structure of a projector in the related art.

FIG. 4 is a cross-sectional view schematically showing the cooling structure of the projector in the related art.

FIG. 5 is a plan view schematically showing the cooling structure of the projector in the related art.

### REFERENCE SYMBOLS

1: optical deflection element

2: reflective surface

3: heat conducting member

4: mounting plate

5: foreign matter intrusion preventing frame

6: light shielding plate

7: heat pipe

8: light source

9: emitted light

10: incident light

11: cooling surface

12: cooling effect

17: cooling air

18: heat radiating fin

20: projector

### BEST MODE FOR CARRYING OUT THE INVENTION

An embodiment of the present invention will be described below in reference to the drawings.

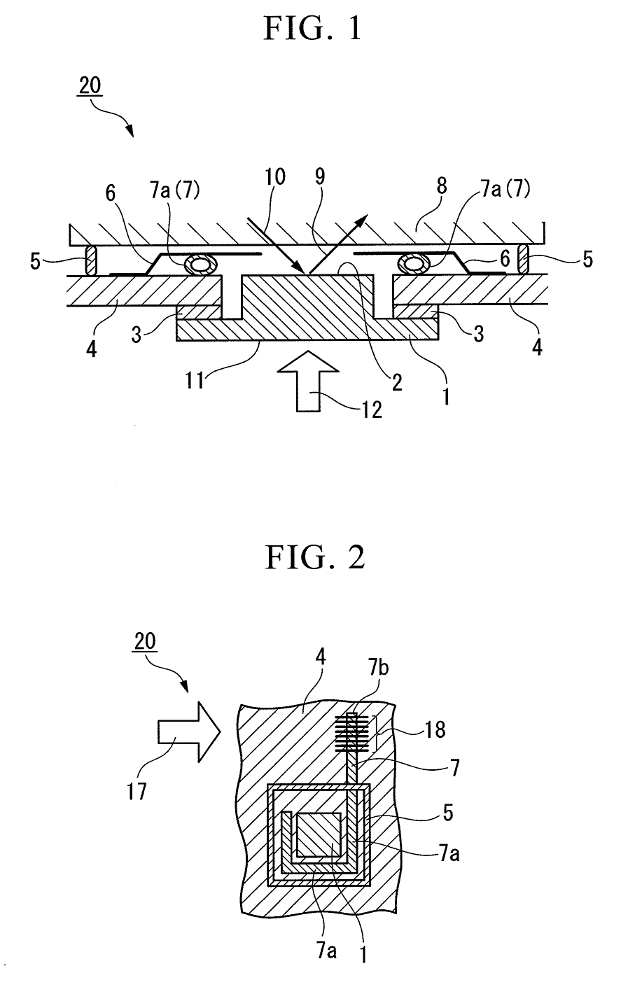

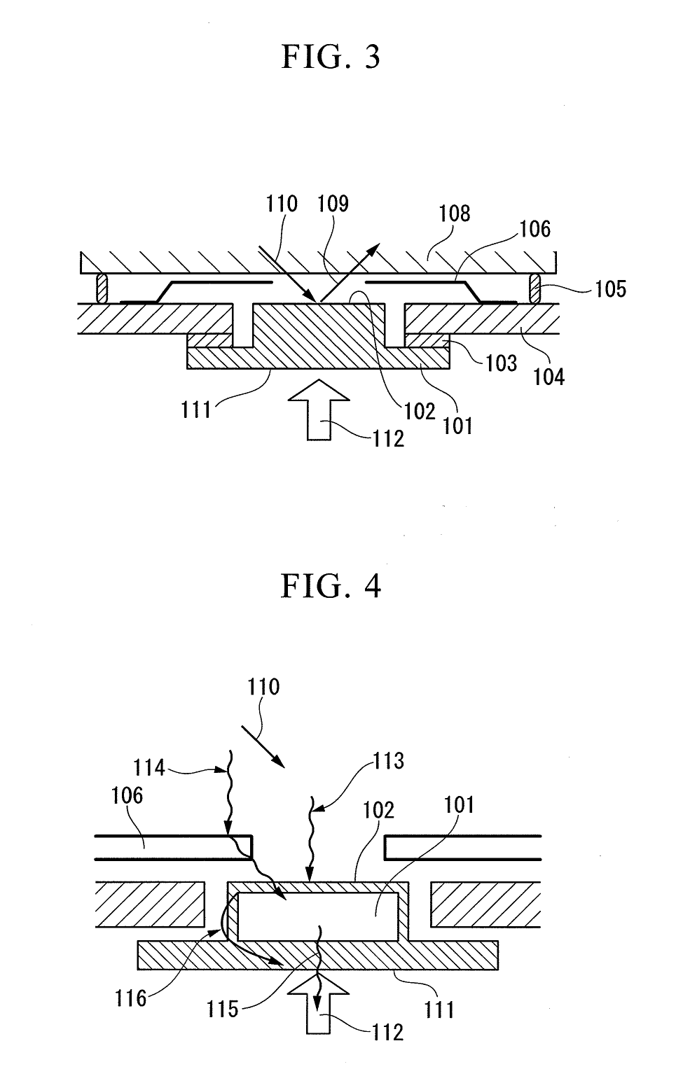

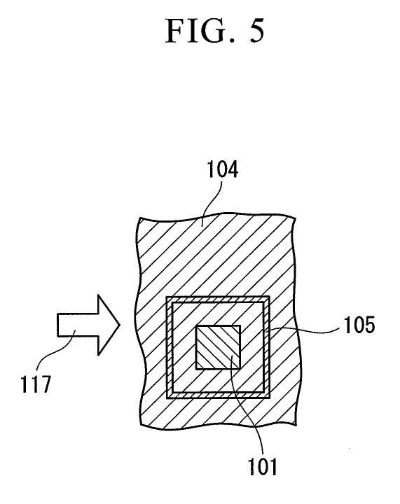

FIG. 1 is a schematic cross-sectional view showing a cooling structure of a projector according to an embodiment of the present invention. Further, FIG. 2 is a plan view showing the cooling structure of the projector according to the embodiment of the present invention.

Meanwhile, FIGS. 1 and 2 are views used to describe the cooling structure of a projector according to an embodiment of the present invention. The dimensions, such as size and thickness, of each component shown in drawings may be different from those of each component of the cooling structure of an actual projector.

A cooling structure of a projector according to an embodiment of the present invention will be described first.

As shown in FIGS. 1 and 2, a cooling structure 20 of a projector mainly includes a light source 8, an optical deflection element 1 having a reflective surface 2, a mounting plate 4 that holds the optical deflection element 1 with a heat conductive member 3 interposed between itself and the optical deflection element so that the reflective surface 2 faces the light source 8, a foreign matter intrusion preventing frame 5 that is provided between the light source 8 and the mounting plate 4 so as to surround the reflective surface 2, and a heat pipe 7 that includes a heat receiving portion 7a and a heat radiating portion 7b.

Further, the heat receiving portion 7a of the heat pipe 7 is disposed so as to surround three sides of the optical deflection element 1 as shown in FIG. 2. Furthermore, the heat radiating portion 7b is provided on the mounting plate 4 outside the foreign matter intrusion preventing frame 5.

The optical deflection element 1 includes a reflective surface 2 that is an aggregate of small mirrors for immediately selecting colors, and an electronic circuit such as transistors for driving the mirrors. Moreover, as shown in FIG. 1, light corresponding to a necessary color is selected from incident light 10, which is input from the light source 8, by the reflective surface 2 of the optical deflection element 1 and is projected onto a screen as emitted light 9 so as to form an image.

As shown in FIG. 1, the optical deflection element 1 includes the reflective surface 2 and a cooling surface 11 that is formed on the side opposite to the reflective surface 2.

The cooling surface 11 is connected to a heat sink that is used for air cooling, or a cooling device (not shown) that is a water-cooling component. Accordingly, heat generated inside the optical deflection element 1 is removed by a cooling effect (an arrow 12 shown in FIG. 1) of a cooling device. Therefore, the temperature of the optical deflection element is controlled and is less than or equal to a prescribed temperature so that a drive circuit operates normally.

As shown in FIG. 1, the heat conducting member 3 is provided at a connecting portion where the optical deflection element 1 is connected to the mounting plate 4. It is preferable that a flexible sheet made of indium or a composite material thereof be selected as the heat conducting member 3 in order to increase a micro and thermal contact area between the optical deflection element 1 and the mounting plate 4.

As shown in FIG. 1, a light shielding plate 6 is provided between the light source 8 and the optical deflection element 1 and is fixed to the mounting plate 4 by screws or the like. Accordingly, it may be possible to efficiently irradiate the reflective surface 2 with the incident light 10.

Copper or the like is used as a material of the mounting plate 4. As shown in FIG. 1, the heat pipe 7 is connected to the mounting plate 4. The mounting plate 4 and the heat pipe 7 are connected to each other by soldering or brazing. If water is used as a fluid flowing in the heat pipe 7 and a copper pipe is used as the heat pipe 7, it is easy to perform soldering or brazing between the mounting plate 4 and the heat pipe and it may be possible to integrally form the mounting plate and the heat pipe.

Further, the heat pipe 7 may be connected to only the mounting plate 4. However, if the heat pipe comes into thermal contact with the light shielding plate 6 as well as the mounting plate as shown in FIG. 1 in order to further improve cooling performance, cooling is even more effective.

The area of the heat receiving portion 7a of the heat pipe 7 is determined according to the amount of heat generated in the optical deflection element 1, the amount of heat radiated from the optical deflection element, the amount of heat transported to the heat pipe 7, a prescribed temperature, and the like. That is, if the diameter and length of the copper pipe are determined, the equivalent thermal conductivity of the heat pipe 7 is determined. The equivalent thermal conductivity of the heat pipe 7 is in the range of about 5000 to 20000 W/m·K.

As shown in FIG. 2, the heat receiving portion 7a of the heat pipe 7 is disposed so as to surround three sides of the optical deflection element 1. Meanwhile, the heat receiving portion 7a of the heat pipe 7 has been disposed so as to surround three sides of the optical deflection element 1 in this embodiment, but is not limited thereto.

For example, it is preferable that the heat receiving portion surround at least one side of the optical deflection element (be disposed along one side in the case of one side). Meanwhile, if the heat receiving portion surrounds four sides of the optical deflection element, it may be possible to further improve heat transport performance.

As shown in FIGS. 1 and 2, the foreign matter intrusion preventing frame 5 is provided between the light source 8 and the mounting plate 4 so as to surround the reflective surface 2 of the optical deflection element 1. The foreign matter intrusion preventing frame 5 is mounted by an adhesive material, an adhesive tape, or the like.

The foreign matter intrusion preventing frame 5 is provided between the light source 8 and the mounting plate 4, and prevents foreign matter such as dirt from intruding into the periphery of the reflective surface 2 of the optical deflection element 1.

As shown in FIG. 2, the foreign matter intrusion preventing frame 5 is mounted on an upper surface of the heat pipe 7 at a portion where the foreign matter intrusion preventing frame 5 and the heat pipe 7 intersect with each other. Further, as shown in FIG. 2, the heat radiating portion 7b of the heat pipe 7 is disposed outside the foreign matter intrusion preventing frame 5. For this reason, as shown in FIG. 2, it may be possible to blow cooling air 17 onto the heat radiating portion 7b. Therefore, it may be possible to improve the cooling effect.

Moreover, heat radiating fins 18 are formed at the heat radiating portion 7b of the heat pipe 7 as shown in FIG. 2. The cooling structure 20 of the projector may radiate heat from the optical deflection element 1 via only the mounting plate 4. However, it may be possible to increase the heat radiation area by forming the heat radiating fins 18 at the mounting plate 4.

Further, since the heat radiation area is increased, the equivalent thermal conductivity of the heat pipe 7 as well as the amount of radiated heat is increased. Accordingly, it may be possible to effectively lower the temperature of the optical deflection element 1 due to a synergistic effect.

The optimum shape, pitch, and size of the heat radiating fins 18 are determined according to the mounting structure of the projector. For example, if plate fins are used at a place where the direction of air is constant, the pitch of the fins is set to be large (about 5 to 10 mm) in the case of natural air cooling where air is not blown by a fan. As the air speed is increased, the pitch of the fins is set to be small (about 2 mm). As a result, an optimum amount of radiated heat is obtained.

The operation of the cooling structure 20 of the projector according to this embodiment will be described in detail below with reference to FIGS. 1 and 2.

First, as shown in FIG. 1, incident light 10 input from the light source 8 is reflected by the reflective surface 2 of the optical deflection element 1 and becomes emitted light 9. In this case, energy of the light becomes radiant heat, so that the optical deflection element 1 is heated. Further, radiation occurs through the light shielding plate 6 that is provided between the light source 8 and the optical deflection element 1.

The radiant heat is transferred to the heat conducting member 3 from the optical deflection element 1, and is transferred to the mounting plate 4. Further, since the heat pipe 7 is disposed on the mounting plate 4 so as to surround the optical deflection element 1, the radiant heat is transferred to the heat pipe 7. The heat pipe 7 is filled with liquid such as water of which the pressure is reduced, and is sealed. Accordingly, if there is a difference in temperature, a heat cycle of evaporation-condensation is created.

The volume of the liquid, which is evaporated by the heat receiving portion 7a, expands and the pressure of the liquid is increased. Simultaneously, the liquid immediately radiates heat to the heat radiating portion 7b of which pressure is low, and is liquefied. The liquid returns to the heat receiving portion 7a again due to capillarity that is caused by capillary tubes called wicks in the heat pipe 7.

The equivalent thermal conductivity of the heat pipe 7, which is determined by boiling heat transfer, is 10 to 20 times of thermal conductivity of metal such as copper.

Accordingly, it may be possible to transport heat to the heat radiating portion 7b without increasing the thickness of the mounting plate 4, that is, without changing an optically important distance between the light source 8 and the reflective surface 2 of the optical deflection element 1.

According to the cooling structure 20 of the projector of this embodiment, as described above, the heat receiving portion 7a of the heat pipe 7 is provided between the reflective surface 2 of the optical deflection element 1 and the light shielding plate 6. Further, the heat pipe 7 comes into contact with the mounting plate 4 on which the optical deflection element 1 is mounted.

Accordingly, the optical deflection element 1 receives heat, which is transferred by radiation, before the heat is transferred to the cooling surface 11 formed on the back surface of the optical deflection element 1, and can radiate the heat after transporting heat to the outside of the foreign matter intrusion preventing frame 5. Furthermore, the heat radiating portion 7b is provided with the heat radiating fins 18 that are provided in consideration of the strength of the cooling air 17, the amount of radiant heat, the temperature that should be satisfied by the optical deflection element 1, and the like.

Accordingly, it may be possible to suppress the rise in temperature of the optical deflection element 1 that is caused by the radiant heat radiated from the light source 8. Therefore, even when the brightness of the projector is increased, it may be possible to suppress the temperature of the optical deflection element 1 so that the temperature of the optical deflection element is less than or equal to a prescribed temperature. As a result, it may be possible to lengthen the product life of the optical deflection element 1.

### INDUSTRIAL APPLICABILITY

For example, the present invention may be applied to use for cooling of an optical deflection element of a projector.

1. A projector comprising a light source, an optical deflection element comprising a reflective surface, a mounting plate that holds the optical deflection element with a heat conductive member interposed between the optical deflection element and the mounting plate so that the reflective surface faces the light source, and a foreign matter intrusion preventing frame that is provided between the light source and the mounting plate so as to surround the reflective surface, the projector comprising:
a heat receiving portion that is provided so as to surround at least one side of the optical deflection element;
a heat radiating portion that is provided on the mounting plate outside the foreign matter intrusion preventing frame; and
a heat pipe that comprises the heat receiving portion and the heat radiating portion.

2. The projector according to claim 1,
wherein the heat pipe is formed integrally with the mounting plate.

3. The projector according to claim 1,
wherein the heat radiating portion comprises heat radiating fins, and
the heat radiating fins are mounted on the mounting plate.

4. The projector according to claim 1,
wherein the heat receiving portion is thermally connected to the mounting plate and a light shielding plate provided between the light source and the mounting plate.
